(19) United States
(12) Patent Application Publication
(10) Pub. No.: US 2008/0258349 A1
(43) Pub. Date: Oct. 23, 2008

(54) Method and apparatus for producing containers

(75) Inventor: Daniel Edward Taylor, Monroe, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company

(21) Appl. No.: 11/787,730

(22) Filed: Apr. 17, 2007

(51) Int. Cl. B29C 67/00; B29C 49/00

(52) U.S. Cl. 264/440; 425/90; 425/100; 425/103; 425/532

(57) ABSTRACT

An apparatus and method for producing plastic objects. The apparatus comprises an extruder disposed to extrude at least one parison, a parison coating system and a mold disposed to receive the extruded parison. The parison coating system comprises: a powdered material source; a fluid source interconnected with the powdered material source; and a nozzle connected to the interconnected fluid and powdered material sources. The nozzle is disposed such that the nozzle disperses the powdered material in a spray pattern which interacts with the extruded parison. The method comprises steps of extruding a plastic parison, applying a powdered material coating to the parison, enclosing the coated parison in a mold cavity and expanding the coated parison to the limits of the cavity.

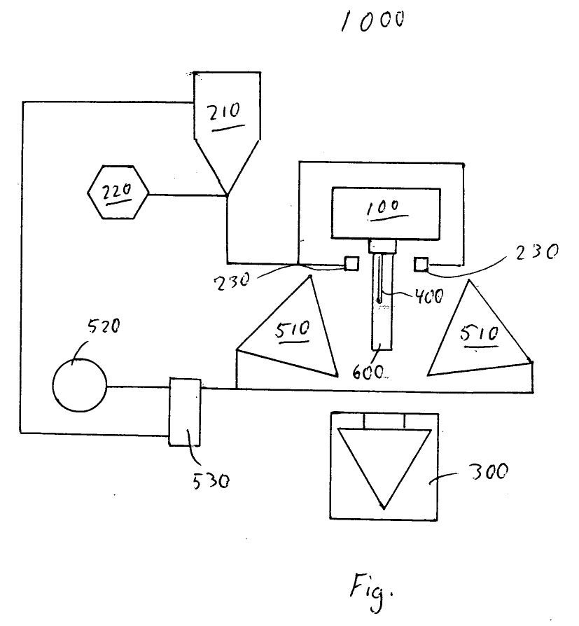

### FIELD OF THE INVENTION

The disclosure relates apparatus and methods for producing plastic objects. The disclosure relates particularly to apparatus and methods for producing plastic containers.

### BACKGROUND OF THE INVENTION

Plastic blow molded objects are well known in the manufacturing arts. Objects are blown from performs or from extruded parisons. The preform or parison may comprise multiple layers. Each of the respective layers may comprise material from a distinct source allowing the respective layers to comprise the same or differing materials. The exterior appearance of the object is largely determined by the color of the outer layer of the preform or parison. The color of the outer layer may be altered by the addition or removal of pigments from the material supply for this layer.

There is often a desire to alter the color of the manufactured objects from a firs color to a second color during the manufacturing process. As the outer layer of the parison is the result of an extrusion process, it is necessary to displace all the material for the outer layer in the extrusion path with new material in order to completely change the color of the outer layer. This displacement can be time consuming and may yield scrap material of mixed coloration which may not be readily reused in the process

It is desired to have apparatus and methods which enable the changing of the exterior color of blown objects without the necessity of purging the extrusion path of the previous color to do so. It is also desired to have apparatus and method for changing the color of plastic objects without altering the composition of the extruded parison.

### BRIEF DESCRIPTION OF THE DRAWINGS

FIGURE is a schematic representation of an embodiment of the apparatus of the invention.

### DETAILED DESCRIPTION OF THE INVENTION

As illustrated in the FIGURE, the apparatus 1000, comprises an extruder 100 comprising an extrusion die. The extruder receives fluid plastic material under pressure and extrudes an annular parison 600 of the material. The parison 600 may comprise one or more layers of material depending upon the design of the extruder. A multi layer parison 600 may be homogeneous or may have layers comprised of distinctly different polymer compounds. The parison 600 is extruded into a parison region of the apparatus. The extruder 100 may comprise multiple extruder dies and may concurrently produce multiple parisons 600. The following description is in terms of a single parison. One of skill in the art will appreciate the applicability of the description to an apparatus producing multiple parisons 600.

The apparatus 1000 comprises a parison powder coating system disposed adjacent to the parison region. The powder coating system may comprise a powdered material source 210, a fluid source 220, which provides a means of fluidizing the powdered material, and one or more nozzles 230 connected to the powdered material and fluid sources. The powder is fluidized and dispersed from the nozzle(s) 230 into the parison area. The coating system directs one or more streams of powdered material toward the parison 600. The streams of material may interact with and coat the extruded parison.

The powdered material may comprises a polymer composition similar or distinct from the polymer compositions of the parison 600. The transition temperature of the powdered plastic may be similar to that of the compositions of the parison 600 such that the powdered material will easily adhere to the parison upon contact. The coating system may be used to coat all or only a portion of the parison 600. An exemplary coating system is the HDLV™ powder coating system of the Nordson Corp, of Westlake, Ohio.

In one embodiment the powder may be electro statically charged to improve the transfer of powder to the parison and adhesion to the parison 600. This effect may be enhanced by the application of an opposing electrostatic charge to the parison 600 or to an electrode 400 present inside the parison 600 as it is extruded.

The parison 600 extends from the extruder die to a predetermined length at a predetermined point in the blow molding cycle. A mold element 300 having one or more mold cavities receives a parison into each mold cavity and the mold element 300 closes upon the parison 600. Compressed air is applied to the interior of the parison 600. The parison 600 is blown up to conform to the shape of the mold cavity. The plastic cools and the blown object is released from the mold. The blow molding operation proceeds as is known in the art.

In one embodiment the apparatus 1000 comprises a material recovery system. The material recovery system comprises one or more material recovery collectors 510 disposed adjacent to the parison extrusion area and connected to a low pressure source 520 such that air flows from the parison extrusion area into the recovery collector 510. A recovery collector 510 may be disposed beneath the parison extrusion area to recover material which falls from the dispersion area. The low pressure source 520 may be a vacuum system or any system as is known in the art for creating air flow from the parison extrusion area into the material recovery collector(s). The material recovery system also comprises a material receiver 530. The material receiver 530 removes collected material from the flowing air and either stores it for reuse or transfers the material to the powdered material source 210 of the powders coating element.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. Apparatus for producing plastic objects, the apparatus comprising:
a) an extruder disposed to extrude at least one parison having an annulus;
b) a parison coating system comprising:
i) a powdered material source;
ii) a fluid source interconnected with the powdered material source; and
iii) a nozzle connected to the interconnected fluid and powdered material sources, the nozzle disposed such that the nozzle disperses the powdered material in a spray pattern which interacts with the extruded parison;
c) a mold disposed to receive the extruded parison.

2. The apparatus according to claim 1, the extruder comprising an electrode within the annulus of the parison.

3. The apparatus according to claim 1, the parison coating system comprising an electrostatic energy source disposed to impart an electric charge to the powdered material prior to the dispersal of the material from the nozzle.

4. The apparatus according to claim 1, comprising a powdered material recovery system.

5. The apparatus according claim 4, the powdered material recovery system comprising:
a) a material collector disposed adjacent to the extruded parison;
b) a vacuum source interconnected with the material collector;
c) a material receiver interconnected with the material collector.

6. A method of producing a plastic object, the method comprising steps of:
a) extruding a parison of thermoplastic material:
b) coating the parison with a powdered plastic material:
c) enclosing the coated parison in a mold cavity having a periphery;
d) expanding the coated parison to the periphery of the mold cavity.

7. The method according to claim 6 comprising the step of applying an electric charge to the powdered material prior to coating the parison.

8. The method according to claim 6 comprising the step of applying an electric charge to the parison.

9. The method according to claim 6 comprising the step of dispersing the powdered material from a nozzle to the parison.

10. The method according to claim 9 comprising the step of creating an electrical potential difference between the nozzle and the parison.

11. The method according to claim 9 comprising the step of collecting powdered plastic material dispersed from the nozzle but not coated on the parison.

12. The method according to claim 9 comprising the step of dispersing powdered plastic material from a plurality of nozzles in a plurality of respective dispersal patterns which dispersal patterns overlap around the periphery of the parison.

13. An apparatus for producing plastic objects, the apparatus comprising:
a) an extruder disposed to extrude at least one parison having an annulus:
b) a mold disposed beneath the extrusion die, the mold comprising a mold cavity;
c) a coating system disposed between the extrusion die and the mold cavity.

14. The apparatus according to claim 13, the coating system comprising:
i) a powdered material source;
ii) a fluid source interconnected with the powdered material source; and
iii) a nozzle connected to the interconnected fluid and powdered material sources, the nozzle disposed such that the nozzle disperses the powdered material in a spray pattern which interacts with the extruded parison.

15. The apparatus according to claim 13 comprising a plurality of nozzles, each of the plurality of nozzles connected to the interconnected fluid and powdered material sources, the nozzle disposed such that the nozzle disperses the powdered material in a spray pattern which interacts with the extruded parison.

16. The apparatus according to claim 13, the extruder comprising an electrode within the annulus of the parison.

17. The apparatus according to claim 13, the parison coating system comprising an electrostatic energy source disposed to impart an electric charge to the powdered material prior to the dispersal of the material from the nozzle.

18. The apparatus according to claim 13, comprising a powdered material recovery system.

19. The apparatus according claim 18, the powdered material recovery system comprising:
a) a material collector disposed adjacent to the extruded parison;
b) a vacuum source interconnected with the material collector;
c) a material receiver interconnected with the material collector.

20. The apparatus according to claim 13, the coating system comprising:
i) a powdered material source;
ii) a fluid source interconnected with the powdered material source; and
iii) a nozzle connected to the interconnected fluid and powdered material sources, the nozzle disposed such that the nozzle disperses the powdered material in a spray pattern which interacts with the extruded parison; and
the system further comprising a powdered material recovery system.
